(19) United States
(12) Patent Application Publication
(10) Pub. No.: US 2026/0268133 A1
(43) Pub. Date: Sep. 10, 2026

(54) METHOD AND DEVICE FOR TRAINING A MACHINE LEARNING SYSTEM

(71) Applicant: Robert Bosch GmbH, Stuttgart (DE)

(72) Inventors: Katharina Ensinger, Asperg (DE); Sebastian Ziesche, Leonberg (DE)

(21) Appl. No.: 19/149,945

(22) PCT Filed: Apr. 2, 2024
(86) PCT No.: PCT/EP2024/058949

§ 371 Date: Jul. 22, 2025

(30) Foreign Application Priority Data
Apr. 6, 2023 (DE) 10 2023 203 241.4

(51) Int. Cl. G06N 3/08

(52) U.S. Cl. CPC G06N 3/08

(57) ABSTRACT

A computer-implemented method for training a machine learning system. The machine learning system is configured to predict a value of a system state of a technical system and/or a surroundings state of the technical system. The method includes: receiving a first time series of values of the system state and/or the surroundings state; ascertaining a second time series of predicted values by means of a simulator and based on the values of the first time series, wherein the simulator predicts a next value of the first time series for time points of the first time series; ascertaining a third time series of predicted values; ascertaining a loss value using a loss function, wherein the loss function includes a term that characterizes a deviation of the third time series from the first time series; training the first neural network and/or the second neural network based on the loss value.

### FIELD

The present invention relates to a method for training a machine learning system, a method for predicting a value of a system state or a surroundings state of a technical system, a training system, a control system, a computer program, and a machine-readable storage medium.

### BACKGROUND INFORMATION

Peralis et al., “Neural Network-Based KKL observer for nonlinear discrete-time systems,” 2022, ieeexplore.ieee.org/document/9992516 describes a KKL observer that is using a neural network.

Predicting the state of a technical system or its surroundings at future points in time is a recurring technical problem in a variety of technical fields. Such predictions are indispensable, in particular when used in model predictive controls (MPC).

In particular physical models of the technical system, which typically determine the future value or values on a time series of measured values of the system state or surroundings state, can be used for prediction. However, the values ascertained in this manner are often not accurate enough to ensure precise control or regulation.

Machine learning methods, in particular neural networks, have proven to be suitable for determining highly accurate predictions. However, one disadvantage of machine learning systems is that their predictions can generally not be reproduced. This means that it is generally not possible to determine why a machine learning system output a particular value as a prediction of a system state or a surroundings state. This feature, also referred to as the “black box”, is encountered in particular in neural networks.

When designing an MPC, there is the problem of choosing between a physical model that outputs potentially inaccurate predictions and a machine learning system that outputs irreproducible predictions.

To combine the advantages of the two types of models, this invention proposes a so-called hybrid model. The inventors were in particular able to determine that a hybrid model based on a Kazantzis-Kravaris/Luenberger (KKL) observer is suitable for ascertaining a prediction of a system state or a surroundings state. Surprisingly, the inventors were able to determine that the use of neural networks within the observer and the ascertainment of two different states within the observer leads to increased prediction accuracy of the hybrid model.

### SUMMARY

In a first aspect, the present invention relates to a computer-implemented method for training a machine learning system, wherein the machine learning system is configured to predict a value of at least one system state of a technical system and/or at least one surroundings state of the technical system.

According to an example embodiment of the present invention, the method comprises the following steps:
receiving a first time series of values of the at least one system state and/or the at least one surroundings state;
ascertaining a second time series of predicted values by means of a simulator and based on the values of the first time series, wherein the simulator predicts a next value of the first time series for time points of the first time series;
ascertaining a third time series of predicted values, wherein the third time series is ascertained based on a KKL observer, wherein the KKL observer receives the second time series as input and predicts a first latent state for time points of the second time series by means of a first neural network of the machine learning system and a second latent state by means of a second neural network of the machine learning system and the third time series is ascertained based on the first latent states and based on the second latent states;
ascertaining a loss value by means of a loss function, wherein the loss function comprise a term that characterizes a deviation of the third time series from the first time series;
training the first neural network and/or the second neural network based on the loss value.

The method of the present invention can in particular be understood as effectively training the part of a machine learning system of a hybrid model. The hybrid model predicts the value of the at least one system state of the technical system and/or the at least one surroundings state of the technical system based on the simulator, which can in particular be understood as a physical model for predicting the value, and the machine learning system. The hybrid model is in particular designed to obtain a time series of values of the system state and/or the surroundings state and to predict one or more future values of the system state and/or the surroundings state based on this time series. For this purpose, the simulator can first ascertain a prediction of the value, which is then refined by the machine learning system. An output value can thus be reproduced using the simulator and, thanks to the refinement, also considered a precise prediction.

The machine learning system is trained in order to ensure a precise prediction. The training method according to the present invention in particular provides that the first time series of values of the at least one system state and/or the at least one surroundings state is made available to the machine learning system, wherein the first time series can be understood as a training date.

A time series can in particular be understood as a plurality of values, each of which is assigned a time point. Values can be measured by means of a sensor, for instance, and each value can be assigned a time of measurement, e.g. as an absolute time or as an offset from the start of the measurement. A time point can preferably also be understood as an index of a value within a time series. A list of measurements can be understood as a time series, for instance, in which an index of an element within the list characterizes a time point of the element. The first time series can in particular be understood as a time series of measurements of the system state and/or the surroundings state.

Based on the first time series, the simulator predicts values for the system state and/or the surroundings state. The simulator can in particular predict a next value of the time series based on portions of the first time series. If the time series comprises 10 values, for example, the simulator can predict the second value based on the first value, predict the third value based on the first and second values, and so on. The simulator preferably provides the first value of the first time series as the first value of the second time series and predicts a value for all other time points of the time series.

The ascertained second time series is then passed to the machine learning system in order to respectively refine the predictions.

For this purpose, the machine learning system uses a KKL observer, which in turn comprises neural networks. Based on the second time series, the KKL observer ascertains first latent states and second latent states of the technical system. A first latent state and a second latent state of a subsequent time point are preferably ascertained based on a value of the second time series. The first latent state can be understood as being observable for the following steps and in terms of control technology, this means that the state can be reconstructed based on the measured values of the system state and/or the surroundings state (i.e. the first time series). The second latent state is ascertained based on the first latent state and can be understood as an unobservable state.

The training based on the loss value can in particular be ascertained by a gradient descent method. In the various embodiments described in this document, it is possible for the steps of the training method to be carried out iteratively, and for each iteration a decision is made whether the first neural network, the second neural network, or both together should be selected for training. This selection can be understood as a hyperparameter of the training method.

The KKL observer can in particular be characterized by the formulas:

$${z}_{n + 1} = {D}_{θ} {z}_{n} + {F}_{θ} {s}_{n} ,$$

$${u}_{n + 1} = {T}_{θ}^{*} ( {z}_{n} ) ,$$

$${v}_{n + 1} = {f}_{θ}^{v} ( {u}_{n} , {v}_{n} , {\hat{y}}_{n} )$$

wherein D_{θ} and F_{θ} are respective matrices, sₙ is value of the second time series at a time point n, zₙ is an intermediate state at the time point n, uₙ is a first latent state at the time point n, vₙ is a second latent state at the time point n,

$${\hat{y}}_{n}$$

is a value of the third time series at the time point n and T_{θ}* is the first neural network and

$${f}_{θ}^{v}$$

is the second neural network.

According to an example embodiment of the present invention, the first neural network is preferably a multilayer perceptron and the second neural network is a gated recurrent unit (GRU).

In various embodiments of the method of the present invention, it is possible that a residual value is ascertained for each second latent state by means of a third neural network of the machine learning system, wherein the third neural network obtains the second latent state as input for ascertaining the residual value, and wherein the loss function comprises an additional term that characterizes a norm of the ascertained residual values.

The inventors were advantageously able to determine that a residual can be learned by the second machine learning system via the second latent state. The residual characterizes a deviation of a prediction of the system state and/or the surroundings state by the first machine learning system and based on the first state to the actual value of the system state and/or the surroundings state. This residual can advantageously be used to improve the prediction of the machine learning system and thus improve the accuracy of the hybrid model.

According to an example embodiment of the present invention, the norm of the residual values can also advantageously be used to regulate the extent to which unobservable states of the system should be included in the ascertainment of the third time series. For example, the term of the loss function that characterizes the norm can be multiplied by a selectable factor in the loss function. A high factor reduces the influence of the unobservable state, while a low factor increases it. The factor can in particular be understood as a hyperparameter of the method.

In the various example embodiments of the present invention, it is further possible that a value of the third time series is predicted at the time point based on a respective first latent state at a time point and by means of a fourth neural network of the machine learning system, wherein the fourth neural network receives the first latent state as input and ascertains an intermediate value, wherein a sum of the intermediate value and a residual value at the time point is provided as a predicted value of the third time series at the time point.

These method steps advantageously enable a prediction of the machine learning system with respect to the first time series to be traced back to the respective observable portions and the unobservable portions.

In the various example embodiments of the present invention, it is further possible that a prediction of a value of the second time series at the time point is ascertained based on a first latent state at a time point and by means of a fifth neural network of the machine learning system, and the loss function comprises a further term that characterizes a deviation of the prediction of the value of the second time series at the time point from the value of the second time series at the time point.

This procedure can be understood to mean that the machine learning system also learns the output of the simulator during training, i.e., also learns how the simulator ascertains its outputs. Because the prediction of the value of the second time series is ascertained based on the first latent state, the first latent state is regularized by these steps such that it best reflects the internal behavior of the simulator. The inventors were able to determine that this limits the first latent state to the observable states of the technical system, which enables a better division into observable and unobservable states and thus further improves the prediction accuracy of the machine learning system.

In the various embodiments of the present invention, it is preferably also possible that, in the step of training, the third neural network and/or the fourth neural network and/or the fifth neural network are additionally or alternatively, trained based on the loss value.

In these embodiments of the present invention, too, the choice of which neural network should be trained in a specific iteration can be understood as a hyperparameter of the method.

In the various embodiments of the present invention, the simulator can comprise a physical model of the technical system, wherein the second time series is ascertained by means of the physical model. The physical model can in particular characterize a differential equation of the technical system.

In a further aspect, the present invention relates to a computer-implemented method for ascertaining a first value of at least one system state of a technical system and/or at least one surroundings state of the technical system comprising the steps:
obtaining a time series of values of the at least one system state or the at least one surroundings state;
ascertaining an intermediate value based on a simulator;
ascertaining the first value by means of a machine learning system and based on the intermediate value, wherein the machine learning system has been trained according to the above training method.

The phrase “wherein the machine learning system has been trained according to the above training method” can be understood to mean that the neural network exists a result of the training.

The expression can alternatively also be understood to mean that the training method is carried out as part of the method for ascertaining the first value.

The method for ascertaining the first value can in particular be considered to be the inference counterpart to the training method. The simulator and the machine learning system can be understood as a hybrid model, wherein the hybrid model is configured to ascertain one or more future values of the system state and/or the surroundings state based on a time series of values of the system state and/or the surroundings state.

For this purpose, the simulator ascertains an intermediate value for each of the future values, which is subsequently refined by the machine learning system. The steps of inference can be understood as being analogous to the steps during training. The ascertainment of the first value by means of the machine learning system can in particular take place as in the method for training.

Example embodiments of the present invention are explained in more detail in the following with reference to the figures.

### BRIEF DESCRIPTION OF THE DRAWINGS

FIG. 1 shows schematically a training method for training a machine learning system, according to an example embodiment of the present invention.

FIG. 2 shows schematically a training system according to an example embodiment of the present invention.

FIG. 3 shows schematically a design of a control system for controlling an actuator, according to an example embodiment of the present invention.

FIG. 4 shows schematically an embodiment example for controlling an at least partially autonomous robot, according to the present invention.

### DETAILED DESCRIPTION OF EXAMPLE EMBODIMENTS

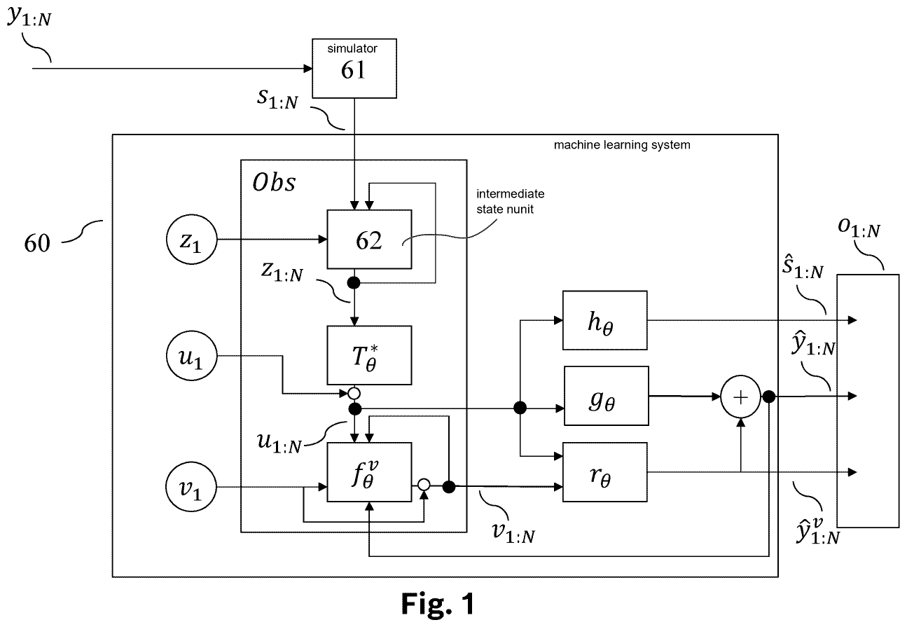

FIG. 1 schematically shows a training method for training a machine learning system (60). For training, a first time series (y_{1:N}) of values of at least one system state and/or surroundings state of a technical system is provided. The time series can in particular be a time series of measured values, e.g. a time series of sensor values, for instance from a temperature sensor, speed sensor, rotation rate sensor, pressure sensor, piezo sensor, acceleration sensor, gas sensor, ammeter, voltmeter or flow sensor. The time series can alternatively also characterize a time series of measured values that are indirectly determined by the technical system. The technical system can be a camera, for example, that records people, vehicles or other moving objects in the surroundings of the camera, in which case the first time series (y_{1:N}) characterizes a trajectory of the person, vehicle, or object.

Based on the first time series, a simulator (61) determines a second time series (s_{1:N}). The second time series characterizes a respective prediction sₙ at a time point n, wherein the prediction is preferably ascertained based on the values of the first time series prior to this time point. The first value of the first time series (y_{1:N}) can preferably be used for the first value of the second time series (s_{1:N}).

A value of the second time series (s_{1:N}) at the time point n can therefore be understood as a prediction that would have been achieved by the simulator (61), if only the values of the time series up to the time point n−1 had been transmitted to the simulator (61). The simulator (61) can optionally be ascertained only on a fixed-size window of values of the first time series (y_{1:N}) prior to the time point n, i.e. for instance on the values y_{n-m:n-1}, wherein yₙ is a value of the first time series (y_{1:N}) at the time point n and the indices below characterize a time point of the time series.

The second time series (s_{1:N}) preferably has the same length as the first time series (y_{1:N}).

The second time series (s_{1:N}) is transmitted to a KKL observer of the machine learning system (60). The KKL observer is configured to ascertain, at a respective time n and based on the second time series (s_{1:N}), a first latent state (u_{1:N}) of the technical system and a second latent state (v_{1:N}) of the technical system at a future time, preferably at the next time point n+1. The first latent state (u_{1:N}) and the second latent state (v_{1:N}) are preferably ascertained based on the formulas:

$${z}_{n + 1} = {D}_{θ} {z}_{n} + {F}_{θ} {s}_{n} ,$$

$${u}_{n + 1} = {T}_{θ}^{*} ( {z}_{n} ) ,$$

$${v}_{n + 1} = {f}_{θ}^{v} ( {u}_{n} , {v}_{n} , {\hat{y}}_{n} )$$

wherein D_{θ} and F_{θ} are respective matrices, zₙ is an intermediate state at a time point n, uₙ is a first latent state at the time point n, vₙ is a second latent state at the time point n,

$${\hat{y}}_{n}$$

is a prediction of the value of the first time series (y_{1:N}) at the time point n and

$${T}_{θ}^{*}$$

is a first neural network and

$${f}_{θ}^{v}$$

is a second neural network.

Parameters of the matrices D_{θ} and F_{θ}, the first neural network and the second neural network can preferably all be adjusted during training. The matrices can alternatively also be set to fixed values. In these cases, D_{θ} is preferably a diagonal matrix with negative eigenvalues and F_{θ} is a unit matrix. The dimensionality of the intermediate states zₙ and the latent states uₙ and vₙ can be freely selected and can be understood as hyperparameters of the training method. The first neural network is preferably a multilayer perceptron, while the second neural network is preferably a GRU.

In the embodiment example, the step zₙ₊₁=D_{θ}zₙ+F_{θ}sₙ is represented by an intermediate state unit (62), wherein the intermediate state unit (62) ascertains a time series (z_{1:N}) of intermediate states zₙ. The first intermediate state (z₁) is preferably characterized by a fixed value, which can be understood as a hyperparameter of the method. The value 0 or, when using multidimensional intermediate states, a zero vector can preferably be selected here.

The intermediate states (z_{1:N}) are passed to the first neural network

$$( {T}_{θ}^{*} ) ,$$

which at each time point zₙ ascertains a first latent state of a future time point, preferably a next time point n+1. It is thus in particular possible to ascertain a time series (u_{1:N}) of first latent states, preferably a first latent state for each time point of the time series (z_{1:N}) of intermediate states. As with the intermediate states, a fixed value that characterizes a hyperparameter of the training can be selected as the first element (u₁) of the time series (z_{1:N}) of first latent states. The value 0 or, when using multidimensional latent states, a zero vector can preferably be selected here. The time series (u_{1:N}) of first latent states preferably has the same length as the time series (z_{1:N}) of intermediate states.

Based on the time series (v_{1:N}) of first latent states, a time series (v_{1:N}) of second latent states is ascertained by means of the second neural network

$$( {f}_{θ}^{v} ) ,$$

preferably according to the above formula. The time series (v_{1:N}) of second latent states preferably has the same length as the time series (u_{1:N}) of first latent states.

Based on the first latent states and the second latent states and by means of a third neural network (r_{θ}), a residual value is ascertained; preferably for each time point of the time series (u_{1:N}) of the first latent states and the time series (v_{1:N}) of the second latent states. Thus a time series

$$( {\hat{y}}_{1 : N}^{v} )$$

of residual values is ascertained. The third neural network (r_{θ}) is preferably characterized by a single linear layer.

Based on the first latent states and by means of a fourth neural network (g_{θ}), intermediate values of a prediction of the first time series (y_{1:N}) are ascertained. Preferably, an intermediate value is ascertained for each first latent state. The intermediate values and the residual values at the same time points n are then added together. The resulting time series

$$( {\hat{y}}_{1 : N} )$$

is provided as a prediction of the first time series (y_{1:N}). The fourth neural network (g_{θ}) is preferably characterized by a single linear layer.

The time series

$$( {\hat{y}}_{1 : N}^{v} )$$

of residual values and the time series

$$( {\hat{y}}_{1 : N} )$$

of predictions of the first time series (y_{1:N}) are provided in an output (o_{1:N}) of the machine learning system (60).

A prediction of the second time series (s_{1:N}) is preferably also ascertained based on the first latent states and by means of a fifth neural network (h_{θ}). This time series

$$( {\hat{s}}_{1 : N} )$$

of predictions is preferably likewise provided in the output (o_{1:N}).

To train the machine learning system (60), the values provided in the output (o_{1:N}) are compared with desired values in order to train the machine learning system (60). A loss value (not shown) can in particular be ascertained based on a loss function. Since the operations in the embodiment example are all differentiable up to the input of the machine learning system (60), the machine learning system (60) can then in particular be trained via a gradient descent method, wherein training of the machine learning system (60) can in particular be understood as adjusting parameters of at least one of the neural networks

$$( {T}_{θ}^{*} , {f}_{θ}^{v} , {h}_{θ} , {g}_{θ} , {r}_{θ} ) .$$

The loss function can in particular comprise a term that characterizes a deviation of the time series

$$( {\hat{y}}_{1 : N} )$$

from predictions of the first time series (y_{1:N}). The loss function preferably further comprises a term that characterizes a deviation of the second time series (s_{1:N}) from the time series (ŝ_{1:N}) of the predictions of the second time series.

The time series can all be understood as vectors, which is why the terms that characterize a deviation can in particular characterize a distance function, in particular a squared Euclidean distance or a Euclidean distance.

The loss function is preferably characterized by the formula:

$$ℒ = {‖ {s}_{1 : N} - {\hat{s}}_{1 : N} ‖}_{2} + {‖ {y}_{1 : N} - {\hat{y}}_{1 : N} ‖}_{2} + λ {‖ {\hat{y}}_{1 : N}^{v} ‖}_{2} ,$$

wherein ∥⋅∥₂ is a Euclidean distance and λ is a factor that scales the norm of the time series

$$( {\hat{y}}_{1 : N}^{v} )$$

of the residual values.

In the method, the respective values of the time series can also be ascertained iteratively by the machine learning system (60) and the machine learning system (60) can be run through completely once in each iteration. This iterative process can be characterized

$${z}_{n + 1} = {D}_{θ} {z}_{n} + {F}_{θ} {s}_{n} ,$$

$${u}_{n + 1} = {T}_{θ}^{*} ( {z}_{n} ) ,$$

$${v}_{n + 1} = {f}_{θ}^{v} ( {u}_{n} , {v}_{n} , {\hat{y}}_{n} ) ,$$

$${\hat{s}}_{n} = {h}_{θ} ( {u}_{n} )$$

$${\hat{y}}_{n}^{v} = {r}_{θ} ( {u}_{n} , {v}_{n} ) ,$$

$${\hat{y}}_{n} = {g}_{θ} ( {u}_{n} ) + {\hat{y}}_{n}^{v}$$

by the formulas:

In FIG. 1, white empty circles describe the inclusion of a value into a time series, and black filled circles describe a duplication of time series for provision to different parts of the machine learning system (60).

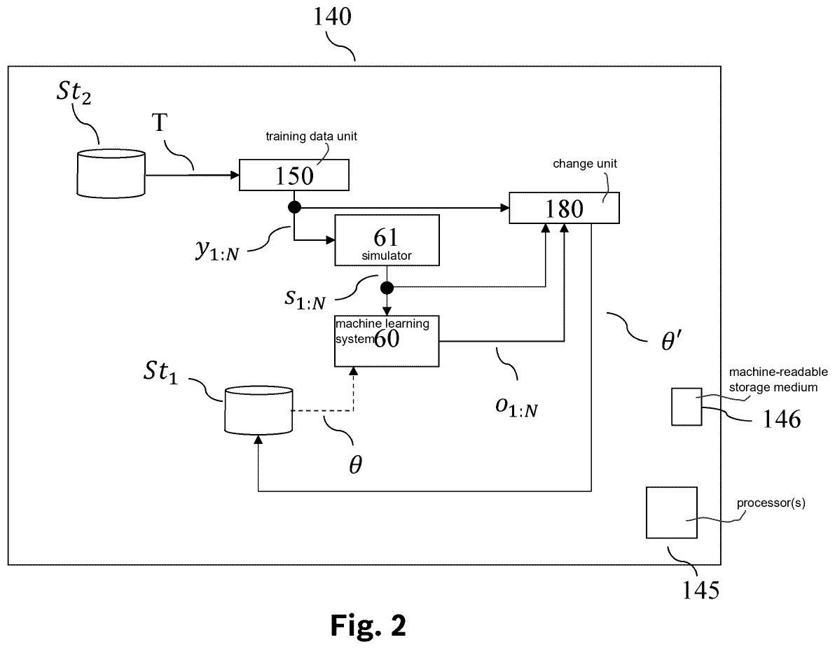

FIG. 2 shows an embodiment example of a training system (140) for training a machine learning system (60) by means of a training data set (T). The training data set (T) comprises a plurality of time series (y_{1:N}) of measured values of at least one system state and/or surroundings state of a technical system that are used to train the machine learning system (60).

For training, a training data unit (150) accesses a computer-implemented database (Stz), wherein the database (Stz) provides the training data set (T). The training data unit (150) preferably randomly ascertains at least a first time series (y_{1:N}) from the training data set (T) and transmits said first time series (y_{1:N}) to the simulator (60). Based on the first time series (y_{1:N}), the simulator (60) ascertains a second time series (s_{1:N}) which is transmitted to the machine learning system (60). The machine learning system (60) ascertains an output signal (o_{1:N}) based on the second time series (s_{1:N}) The first time series (y_{1:N}) and the ascertained output (o_{1:N}) are transmitted to a change unit (180).

The change unit (180) then determines new parameters (θ′) for the machine learning system (60) based on the first time series (y_{1:N}) and the ascertained output (o_{1:N}). For this purpose, the change unit ascertains a loss value based on the loss function from above. The change unit (180) uses the loss value to ascertain the new parameters (θ′). In this embodiment example, this is done using a gradient descent method, preferably stochastic gradient descent, Adam or AdamW. In other embodiment examples, the training can also be based on an evolutionary algorithm or a second-order optimization.

The ascertained new parameters (θ′) are stored in a model parameter memory (St₁). The ascertained new parameters (θ′) are preferably made available to the machine learning system (60) as parameters (θ). The parameters (θ) and new parameters (θ′) refer in particular to parameters and new parameters of the first to fifth neural network.

In other preferred embodiment examples, the described training is iteratively repeated for a predefined number of iteration steps or iteratively repeated until the first loss value falls below a predefined threshold value. Alternatively or additionally, it is also possible that the training is terminated when an average first loss value with respect to a test or validation data set falls below a predefined threshold value. In at least one of the iterations, the new parameters (θ′) determined in a previous iteration are used as parameters (θ) of the machine learning system (60).

The training system (140) can also comprise at least one processor (145) and at least one machine-readable storage medium (146), which includes instructions that, when executed by the processor (145), cause the training system (140) to carry out a training method according to any one of the aspects of the present invention.

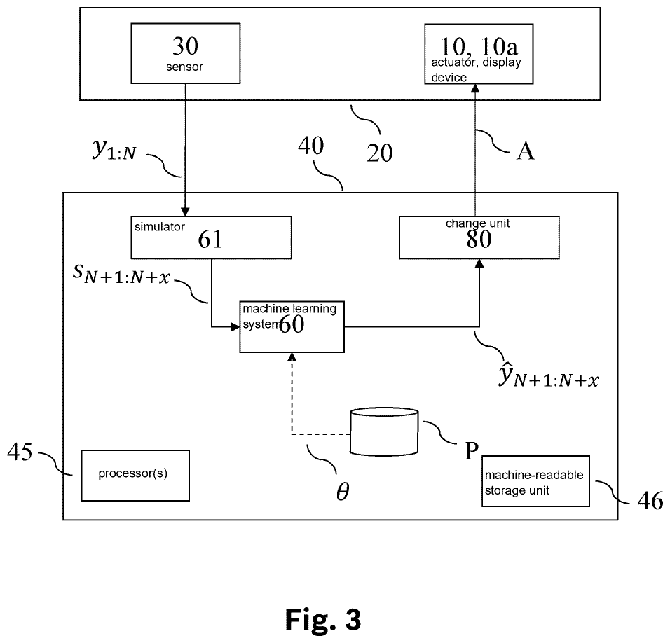

FIG. 3 is a control system (40) that ascertains control signals (A) of an actuator (10) and/or a display device (10a) by means of the machine learning system (60). At preferably regular time intervals, the surroundings (20) of the actuator (10) are acquired in a sensor (30). The sensor signal is transmitted to the control system (40) as a first time series (y_{1:N}) of measured values. From these, the control system (40) ascertains control signals (A) which are transmitted to the actuator (10).

The control system (40) passes the first time series (y_{1:N}) to a simulator (61) which predicts a second time series (s_{N+1:n1+x}) of future measured values based on the first time series (y_{1:N}). This second time series (s_{N+1:N+x}) is transmitted to the machine learning system (60).

The machine learning system (60) is preferably parameterized by the parameters (θ) ascertained during training, which are stored in and provided by a parameter memory (P).

The machine learning system (60) ascertains a third time series

$$( {\hat{y}}_{N + 1 : N + x} )$$

of future measured values based on the second time series (s_{N+1:N+x}). In the embodiment example, a number x of future measured values is predicted, and the number can be freely selected and set by a user. The third time series

$$( {\hat{y}}_{N + 1 : N + x} )$$

is fed to an optional conversion unit (80), which uses them to ascertain control signals (A) that are fed to the actuator (10) to control the actuator (10) accordingly.

The actuator (10) receives the control signals (A), is controlled accordingly and carries out a respective action. The actuator (10) can comprise a (not necessarily structurally integrated) control logic which, from the control signal (A), ascertains a second control signal that is then used to control the actuator (10).

In further embodiments, the control system (40) comprises the sensor (30). In still further embodiments, the control system (40) alternatively or additionally also includes the actuator (10).

In further preferred embodiments, the control system (40) comprises at least one processor (45) and at least one machine-readable storage medium (46) on which instructions are stored that, when executed on the at least one processor (45), cause the control system (40) to carry out the method according to the present invention.

In alternative embodiments, a display unit (10a) is provided as an alternative or in addition to the actuator (10).

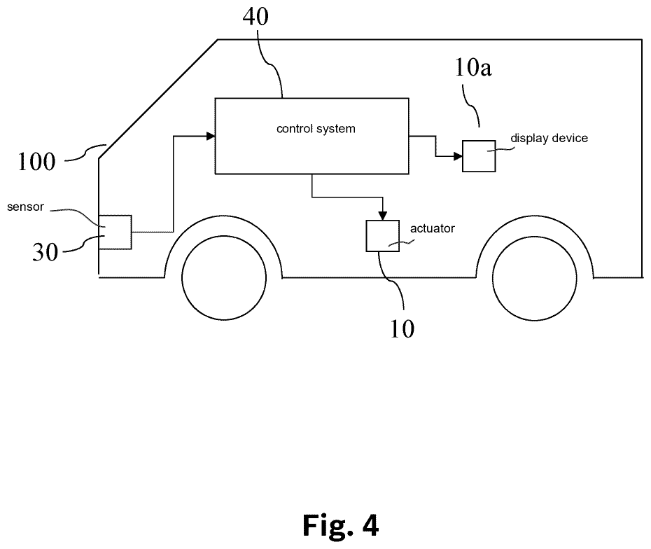

FIG. 4 shows how the control system (40) can be used to control an at least partially autonomous robot, here an at least partially autonomous motor vehicle (100).

The sensor (30) can, for instance, be a video sensor which is preferably disposed in the motor vehicle (100) and is configured to ascertain a time series of positions of other road users, such as vehicles, people, cyclists, or the like.

The actuator (10), which is preferably disposed in the motor vehicle (100), can be a brake, a drive or a steering system of the motor vehicle (100), for example. The control signal (A) can then be ascertained such that the actuator or actuators (10) are controlled, for instance in such a way that the motor vehicle (100) avoids a collision with other road users. The optional conversion unit (80) can in particular carry out model predictive control by taking into account the future positions of the road users in such a way that a travel trajectory planned for the vehicle does not collide with trajectories predicted for the road users based on their future positions.

Alternatively or additionally, the display unit (10a) can be controlled with the control signal (A) and predicted positions of road users, for instance, can be displayed.

The at least partially autonomous robot can alternatively also be another mobile robot (not shown), for example one that moves by flying, swimming, diving, or walking. The mobile robot can also be an at least partially autonomous lawnmower, for instance, or an at least partially autonomous cleaning robot. In these cases too, the control signal (A) can be ascertained such that the drive and/or steering of the mobile robot are controlled in such a way that the at least partially autonomous robot prevents a collision with objects identified by the sensor (30), for example.

The term “computer” includes any device for processing specifiable calculation rules. These calculation rules can be in the form of software, in the form of hardware or also in a mixed form of software and hardware.

A time series can generally be understood as being indexed; i.e. each element of the time series is assigned a unique index, preferably by assigning consecutive whole numbers to the elements included in the time series. If a time series N comprises elements, wherein N is the number of elements in the plurality, the elements are preferably assigned whole numbers from 1 to N.

1-14. (canceled)

15. A computer-implemented method for training a machine learning system, wherein the machine learning system is configured to predict a value of at least one system state of a technical system and/or at least one surroundings state of the technical system, the method comprising the following steps:
receiving a first time series of values of the at least one system state and/or the at least one surroundings state;
ascertaining a second time series of predicted values using a simulator and based on the values of the first time series, wherein the simulator predicts a next value of the first time series for time points of the first time series;
ascertaining a third time series of predicted values, wherein the third time series is ascertained based on a KKL observer, wherein the KKL observer obtains the second time series as input and predicts a first latent state for time points of the second time series using a first neural network of the machine learning system and a second latent state using a second neural network of the machine learning system, and the third time series is ascertained based on the first latent states and based on the second latent states;
ascertaining a loss value using a loss function, wherein the loss function includes a term that characterizes a deviation of the third time series from the first time series;
training the first neural network and/or the second neural network based on the loss value.

16. The method according to claim 15, wherein, based on a value of the second time series at a time point, the KKL observer ascertains a first latent state at a subsequent time and a second latent state at a subsequent time.

17. The method according to claim 16, wherein the KKL observer is characterized by the formulas:
$${z}_{n + 1} = {D}_{θ} {z}_{n} + {F}_{θ} {s}_{n} ,$$
$${u}_{n + 1} = {T}_{θ}^{*} ( {z}_{n} ) ,$$
$${v}_{n + 1} = {f}_{θ}^{v} ( {u}_{n} , {v}_{n} , {\hat{y}}_{n} )$$
wherein D_{θ} and F_{θ} are respective matrices, zₙ is an intermediate state at a time point n, uₙ is a first latent state at the time point n, vₙ is a second latent state at the time point n,
$${\hat{y}}_{n}$$
is a value of the third time series at the time point n and
$${T}_{θ}^{*}$$
is the first neural network and
$${f}_{θ}^{v}$$
is the second neural network.

18. The method according to claim 15, wherein a residual value is ascertained for each second latent state using a third neural network of the machine learning system, wherein the third neural network obtains the second latent state as input for ascertaining the residual value, and wherein the loss function includes an additional term that characterizes a norm of the ascertained residual values.

19. The method according to claim 15, wherein a value of the third time series is predicted at a time point based on a respective first latent state at the time point and using a fourth neural network of the machine learning system, wherein the fourth neural network receives the first latent state as input and ascertains an intermediate value, wherein a sum of the intermediate value and a residual value at the time point is provided as a predicted value of the third time series at the time point.

20. The method according to claim 15, wherein a prediction of a value of the second time series at a time point is ascertained based on a first latent state at the time point and using a fifth neural network of the machine learning system, and the loss function includes a further term that characterizes a deviation of the prediction of the value of the second time series at the time point from the value of the second time series at the time point.

21. The method according to claim 18, wherein, in the step of training, the third neural network is additionally trained based on the loss value.

22. The method according to claim 19, wherein, in the step of training, the fourth neural network is additionally trained based on the loss value.

23. The method according to claim 20, wherein, in the step of training, the fifth neural network is additionally trained based on the loss value.

24. The method according to claim 15, wherein the simulator includes a physical model of the technical system, and wherein the second time series is ascertained using the physical model.

25. The method according to claim 24, wherein the physical model characterizes a differential equation of the technical system.

26. A computer-implemented method for ascertaining a first value of at least one system state of a technical system and/or at least one surroundings state of the technical system, the method comprising the following steps:
obtaining a time series of values of the at least one system state or the at least one surroundings state;
ascertaining an intermediate value based on a simulator;
ascertaining the first value using a machine learning system and based on the intermediate value, wherein the machine learning system has been trained by:
receiving a first time series of values of the at least one system state and/or the at least one surroundings state,
ascertaining a second time series of predicted values using the simulator and based on the values of the first time series, wherein the simulator predicts a next value of the first time series for time points of the first time series,
ascertaining a third time series of predicted values, wherein the third time series is ascertained based on a KKL observer, wherein the KKL observer obtains the second time series as input and predicts a first latent state for time points of the second time series using a first neural network of the machine learning system and a second latent state using a second neural network of the machine learning system, and the third time series is ascertained based on the first latent states and based on the second latent states,
ascertaining a loss value using a loss function, wherein the loss function includes a term that characterizes a deviation of the third time series from the first time series,
training the first neural network and/or the second neural network based on the loss value.

27. An apparatus, comprising:
a training device configured to train a machine learning system, wherein the machine learning system is configured to predict a value of at least one system state of a technical system and/or at least one surroundings state of the technical system, the training device configured to:
receive a first time series of values of the at least one system state and/or the at least one surroundings state,
ascertain a second time series of predicted values using a simulator and based on the values of the first time series, wherein the simulator predicts a next value of the first time series for time points of the first time series,
ascertain a third time series of predicted values, wherein the third time series is ascertained based on a KKL observer, wherein the KKL observer obtains the second time series as input and predicts a first latent state for time points of the second time series using a first neural network of the machine learning system and a second latent state using a second neural network of the machine learning system, and the third time series is ascertained based on the first latent states and based on the second latent states,
ascertain a loss value using a loss function, wherein the loss function includes a term that characterizes a deviation of the third time series from the first time series,
train the first neural network and/or the second neural network based on the loss value.

28. An apparatus, comprising:
a control device configured to ascertain a first value of at least one system state of a technical system and/or at least one surroundings state of the technical system, the control device configured to:
obtain a time series of values of the at least one system state or the at least one surroundings state,
ascertain an intermediate value based on a simulator,
ascertain the first value using a machine learning system and based on the intermediate value, wherein the machine learning system has been trained by:
receiving a first time series of values of the at least one system state and/or the at least one surroundings state,
ascertaining a second time series of predicted values using the simulator and based on the values of the first time series, wherein the simulator predicts a next value of the first time series for time points of the first time series,
ascertaining a third time series of predicted values, wherein the third time series is ascertained based on a KKL observer, wherein the KKL observer obtains the second time series as input and predicts a first latent state for time points of the second time series using a first neural network of the machine learning system and a second latent state using a second neural network of the machine learning system, and the third time series is ascertained based on the first latent states and based on the second latent states,
ascertaining a loss value using a loss function, wherein the loss function includes a term that characterizes a deviation of the third time series from the first time series,
training the first neural network and/or the second neural network based on the loss value;
wherein the control device is configured to control an actuator and/or a display device based on the first value.

29. A non-transitory machine-readable storage medium on which is stored a computer program for training a machine learning system, wherein the machine learning system is configured to predict a value of at least one system state of a technical system and/or at least one surroundings state of the technical system, the computer program, when executed by a processor, causing the processor to perform the following steps:
receiving a first time series of values of the at least one system state and/or the at least one surroundings state;
ascertaining a second time series of predicted values using a simulator and based on the values of the first time series, wherein the simulator predicts a next value of the first time series for time points of the first time series;
ascertaining a third time series of predicted values, wherein the third time series is ascertained based on a KKL observer, wherein the KKL observer obtains the second time series as input and predicts a first latent state for time points of the second time series using a first neural network of the machine learning system and a second latent state using a second neural network of the machine learning system, and the third time series is ascertained based on the first latent states and based on the second latent states;
ascertaining a loss value using a loss function, wherein the loss function includes a term that characterizes a deviation of the third time series from the first time series;
training the first neural network and/or the second neural network based on the loss value.
